(19) United States
(12) Patent Application Publication
(10) Pub. No.: US 2022/0306922 A1
(43) Pub. Date: Sep. 29, 2022

(54) ADHESIVE COMPOSITION AND METHOD OF MAKING AND USING THE SAME

(71) Applicants: Trustees of Tufts College, Medford, MA (US); University of Bari Aldo Moro, Bari (IT)

(72) Inventors: Fiorenzo G. Omenetto, Lexington, MA (US); Gianluca M. Farinola, Bari (IT); Marco Lo Presti, Bari (IT)

(21) Appl. No.: 17/596,896

(22) PCT Filed: Jun. 19, 2020
(86) PCT No.: PCT/US2020/038752

§ 371 Date: Dec. 20, 2021

Related U.S. Application Data
(60) Provisional application No. 62/864,444, filed on Jun. 20, 2019.

(51) Int. Cl. C09J 189/00

(52) U.S. Cl. CPC C09J 189/00

(57) ABSTRACT

An adhesive composition and methods of making and using the same are disclosed. The composition includes a polymeric component and a metal cation or an oxidant. The polymeric component includes a silk fibroin protein and a catecholamine. The metal cation and/or the oxidant is present in an amount sufficient to initiate complexing and/or cross-linking of the adhesive composition.

### CROSS-REFERENCE TO RELATED APPLICATIONS

This application is related to, claims priority to, and incorporated herein by reference for all purposes U.S. Provisional Patent Application No. 62/864,444, filed Jun. 20, 2019.

### STATEMENT REGARDING FEDERALLY FUNDED RESEARCH

This invention was made with government support under N00014-16-1-22437 awarded by the Office of Naval Research. The government has certain rights in the invention.

### BACKGROUND

In the field of adhesives, synthetic adhesives have long been favored due to the improved performance that can be achieved. More recently, however, biocompatible products that can be prepared with as few harsh chemicals as possible are increasingly preferred. Some attempts at making biocompatible adhesives from natural products exist, but the performance of the adhesives has not approached the performance of synthetic adhesives.

A need exists for improved adhesives that are biocompatible. A need exists for improved adhesives that are non-toxic.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

Specific structures, devices, and methods relating to x-ray imaging are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

It should be appreciated that compositions that undergo some chemical transformation during their use can be described in various ways. For instance, dissolving NaCl in water can be described as water having an NaCl concentration or water having a concentration of Na⁺ and Cl⁻ ions. In the present disclosure, components of chemical compositions can be described either as the form they take prior to any chemical transformation or the form they take following the chemical transformation. If there is any ambiguity to a person having ordinary skill in the art, the assumption should be that the component is being described in the context of the particular composition being described (i.e., if describing a finished product or an intermediary after a given chemical transformation, then the chemically transformed entity is being described, and if describing a starting product or intermediary prior to the chemical transformation, then the untransformed entity is being described.

The present disclosure relates to adhesive compositions. Typically, adhesive compositions are applied in thin layers or films. As used here, the term “film” refers to a layer of material, either solid or liquid, which has a thickness suitable for use in an adhesive application.

In an aspect, the present disclosure provides an adhesive composition. The adhesive composition comprises a polymeric component comprising silk fibroin protein and a catecholamine. The adhesive also comprises a metal cation and/or an oxidant. The metal cation can induce complexing of the polymeric component. The oxidant can induce cross-linking of the polymeric component. The metal cation and/or the oxidant are present in an amount sufficient to initiate complexing and/or cross-linking of the adhesive composition. This complexing and cross-linking occurs in a fashion understood by those having ordinary skill in the art. A non-limiting description of this complexing and crosslinking is provided below in Example 1.

The catecholamine can be present in the polymeric component in a dry-solid-basis amount by weight of between 0.05% and 83.0%, including but not limited to, between 0.1% and 50.0%, between 0.2% and 45.0%, between 0.5% and 40.0%, between 1.0% and 35.0%, between 5.0% and 30.0%, between 10.0% and 42.5%, between 2.5% and 15.0%, between 7.5% and 25.0%, or between 12.5% and 20.0%. In some cases, the catecholamine can be present in the composition in an amount of at least 0.0056 μg (0.002 mM) of catecholamine per 1 mg of silk fibroin. The catecholamine can be a water-soluble catecholic compound understood by those having ordinary skill in the art to be suitable for use in the adhesive compositions described herein. The catecholamine can be dopamine (e.g., polydopamine, dopamine monomer, etc.), epinephrine, norinephrine, other water-soluble catecholic compounds capable of self-polymerization, and combinations thereof. The catecholamine can be dopamine. The catecholamine can be polydopamine. The catecholamine can be a dopamine monomer. The catecholamine can be present as a mixture of polydopamine and dopamine monomer.

The silk fibroin protein can be present in the polymeric component in a dry-solid-basis amount by weight of between 17.0% and 99.9%, including but not limited to, between 50.0% and 99.8%, between 60.0% and 99.5%, between 65.0% and 99.0%, between 70.0% and 95.0%, between 57.5% and 90.0%, between 85.0% and 97.5%, between 75.0% and 92.5%, or between 80% and 87.5%. The weight average molecular weight of the silk fibroin protein can be between 60 kDa and 230 kDa, including but not limited to, between 70 kDa and 150 kDa, between 75 kDa and 125 kDa, between 90 kDa and 110 kDa, or between 95 kDa and 105 kDa, including a weight average molecular weight of about 100 kDa. In some cases, the number average molecular weight of the silk fibroin protein can fall within the same ranges described in the previous sentence.

The oxidant can be present in the adhesive composition in a dry-solids-basis amount by weight relative to the dry-solid-basis amount by weight of the silk fibroin protein and the dopamine of between 0.001% and 1.0%, including but not limited to, between 0.005% and 0.9%, between 0.01% and 0.75%, between 0.1% and 0.5%, between 0.025% and 0.25%, between 0.05% and 0.1%, between 0.25% and 0.85%, or between 0.002% and 0.05%. In some cases, the oxidant can be present in an amount of at least 0.005 mg per 1 mg of silk fibroin.

The oxidant can be an oxidant understood by those having ordinary skill in the chemical arts to be suitable for oxidizing catechol moieties for the purpose of initiating cross-linking between those catechol moieties. The oxidant can be selected from the group consisting of KIO₄, KMnO₄, H₂O₂, ClO⁻, ClO₂⁻, ClO₃⁻, ClO₄⁻, other inorganic oxidants understood by those having ordinary skill in the art to be suitable for use as an oxidant in this disclosure, enzymatic oxidants (e.g., tyrosinases, phenol oxidase, polyphyenol oxidase, and the like), the like, and combinations thereof.

The metal cation can be a metal cation understood by those having ordinary skill in the chemical arts to be suitable for complexing catechol moieties. The metal cation can have a +2, +3, or +4 oxidation state. In some cases, the metal cation can have a +3 oxidation state. The metal cation can be selected from the group consisting of Fe³⁺, Cu²⁺, Ca²⁺, Ce³⁺, Ni²⁺, Zn²⁺, Al³⁺, Co³⁺ and Ti⁴⁺, the like, and combinations thereof. The metal cation itself can be provided by a corresponding salt, such as FeCl₃, or by another means understood to those having ordinary skill in the chemical arts.

A first subset of the adhesive compositions described above can include the polymeric component and the oxidant. In some cases, the first subset of the adhesive compositions can be substantially free of the metal cation.

In some cases, the first subset of the adhesive compositions, the polymeric component can include the dopamine in a dry-solids-basis amount by weight of between 25.0% and 50.0%, including but not limited to, between 30.0% and 45.0%, or between 35.0% and 40.0%.

A second subset of the adhesive compositions described above can include the polymeric component and the metal cation. In certain cases, the second subset of the adhesive compositions can be substantially free of the oxidant.

In some cases, the adhesive compositions can include the metal cation and the oxidant. A person having ordinary skill in the chemical arts would appreciate the need in these cases to balance the degree of oxidation of catechol moieties, which initiates cross-linking, with the need to keep sufficient numbers of catechol moieties non-oxidized, because oxidized catechol moieties do not complex with metal cations as efficiently as non-oxidized catechol moieties.

The adhesive compositions described herein, including the first and second subsets, can have surprisingly impressive performance qualities. Specific examples are discussed below in Example 1. When discussing some of these adhesive properties, a minimum adhesive strength may be the only value provided. This is not to suggest that the adhesive compositions described herein possess no upper boundary to their adhesive properties, but rather that when considering adhesive properties there is typically a minimum adhesion strength that is required for a given purpose and merely exceeding that minimum is sufficient.

In certain cases, the adhesive compositions described herein can have an underwater adhesive strength of at least 0.025 MPa per 250 mm², including but not limited to, at least 0.1 MPa per 250 mm², at least 0.4 MPa per 250 mm², at least 1.0 MPa per 250 mm², or at least 2.0 MPa per 250 mm².

In certain cases, the adhesive compositions described herein can have and in-air adhesive strength of at least 0.05 MPa per 250 mm², including but not limited to, at least 0.1 MPa per 250 mm², at least 0.5 MPa per 250 mm², at least 0.75 MPa per 250 mm², at least 1.0 MPa per 250 mm², at least 1.5 MPa per 250 mm², or at least 2.0 MPa per 250 mm².

The adhesive composition can form a film with the properties described herein. The film can have a total polymer content of between 0.05 mg/cm² and 100 mg/cm², including but not limited to, between 1.0 mg/cm² and 25 mg/cm², between 0.1 mg/cm² and 10 mg/cm², between 0.5 mg/cm² and 2.5 mg/cm², or between 0.25 mg/cm² and 1.0 mg/cm².

In an aspect, the present disclosure provides a kit. The kit contains the ingredients necessary to form the adhesive composition described elsewhere herein. The kit can include a first component and a second component, though additional components may or may not be present. The first component and the second component are at least temporarily prevented from contacting one another. The first component can include the polymeric component described above with respect to the adhesive composition. It should be appreciated that any crosslinking or complexing that results in the adhesive composition having an adhesive strength would not be present or would be present to a lesser extent in the first component than in the adhesive composition.

The first component can be a liquid or a solid. In cases where the first component is a liquid, the first component can be an aqueous solution, an aqueous suspension, or a combination thereof. In cases where the first component is a solid, the first component can be a solid film.

The second component can be an aqueous solution, an aqueous suspension, or a combination thereof. The second component can have dopamine present in a concentration of at least 50 mM, at least 100 mM, at least 150 mM, at least 175 mM, at least 200 mM, at least 500 mM, at least 1.0 M, or at least 1.5 M. The second component can have dopamine present in a concentration of up to 2.0 M.

The kit can include a housing having a first compartment and a second compartment. The first compartment contains the first component and the second compartment contains the second component.

The kit can take a physical form understood by those having ordinary skill in the art to be suitable for use with a dual-component adhesive, such as a dual syringe, a frangible packaging, or the like.

Combining the first component and the second component provides the adhesive composition described herein.

In some cases, the adhesive composition can be presented as a mixture of the various components described herein in the absence of water. The mixture can be in the form of a film or a powder. The mixture can include lyophilized silk fibroin mixed with the other components in solid form. The mixture can then have its adhesive properties activated by addition of water.

In an aspect, the present disclosure provides a method for making an adhesive composition. The method includes: a) forming a film from a mixture comprising a silk fibroin protein and a catechol; and b) contacting the film with an oxidant and/or a metal cation, thereby forming an adhesive composition.

In an aspect, the present disclosure provides a method for making a kit. The method of making a kit includes mixing the silk fibroin protein and the dopamine to make the first composition and providing the second composition.

In an aspect, the present disclosure provides a method for using a kit. The method for using a kit includes substantially the same steps as the method for making an adhesive composition, but without the method steps that are required for making the kit.

Any of the methods described herein can be performed in the absence of organic solvent. Any of the methods described herein can be performed in the absence of alcohols. Any of the methods described herein can be performed without exceeding a temperature of 100° C. Any of the methods described herein can be performed without exceeding a pressure of 1 MPa.

In some cases, the adhesive compositions of the present disclosure exhibit behavior that is similar to a cement. In such cases, the adhesive composition of the present disclosure may be particularly useful in dental applications, such as dental devices and products that typically utilize conventional dental cement compositions.

A surprising feature of the adhesive compositions of the present disclosure is the ease with which they are used. Most existing adhesives require a curing process that involves heat, radiation, and/or pressure. The adhesive compositions of the present disclosure can achieve impressive adhesive strength merely by application and drying of the various components in the proper order.

A surprising feature of the adhesive compositions of the present disclosure is the small quantity of material required to achieve significant adhesive strength.

A surprising feature of the adhesive compositions of the present disclosure is the lack of organic solvents, including alcohols, in their preparation and use. The absence of these solvents allows for much broader use of these biocompatible adhesive compositions, because they can be used in aqueous biological environments without fear of the impact of retained or residual organic solvents on those environments.

A surprising feature of the adhesive compositions of the present disclosure is the ability to detach and re-attached the adhesive while retaining much of the original adhesive strength. The first subset of adhesive composition discussed above can provide particularly good adhesive strength following detachment and re-attachment. In some cases, the adhesive composition can require some degree of retained hydration to possess the ability to detach and re-attached, as described.

A surprising feature of the adhesive compositions of the present disclosure is the underwater adhesion strength that was achieved. The second subset of the adhesive compositions discussed above can provide particularly strong underwater adhesion strength.

A surprising feature of the adhesive composition of the present disclosure is that no synthetic steps are required for the production. This is a very simple procedure for making an adhesive and, more specifically, for making an underwater adhesive.

### Examples

The following Example describes the creation of exemplary embodiments of the present invention including both compositions and methods for making the same. Provided compositions enjoy enhanced properties over previously known adhesives including, but not limited to compatibility with aqueous environments, biocompatibility, biodegradability, enhanced adhesive strength particularly in aqueous environments, and resistance to swelling upon exposure to an aqueous environment.

Here we report a new biomaterial composed by silk fibroin, polydopamine and Fe³⁺ with tunable adhesive properties superior to any bioinspired adhesive and some commercial glues. This material exhibits astonishing adhesion even underwater, mimicrying natural mussel byssus. Moreover, it is a completely biodegradable and atoxic (potentially edible) material that only need water as a solvent to be activated. This new biomaterial was designed in order to create a long and stable polypeptidic backbone with silk fibroin, interacting through cross-link reactions and supramolecular interactions with polydopamine, a well-known polymer rich in catechols moieties able to bind iron and other metals. Furthermore, comparing our new glue to other synthetic or bioinspired ones, we use an extremely low quantity of material, from 4 (Burke, 2015) to 100 (Guvendiren, 2009) times lower. Finally, synthetic procedure and curing conditions are the simplest ever reported (Youbing, 2016): once the water soluble polymers are mixed together and spread on the surface, the simple addition of a solution of oxidant and/or Fe′ on the other face of the material is enough to obtain adhesion. Simply varying the polymers and/or oxidant/iron ratios, we have created a totally water-based, biocompatible and non-toxic bioinspired adhesive with the highest underwater adhesive properties today known in literature (Li, 2015).

Silk Fibroin Adhesive Preparation

For each sample, we poured 1.4 mg of silk fibroin and a variable quantity of dopamine hydrochloride, from 8 μg to 0.8 mg, casting 20 μL on each glass slide. For selected samples, we used 4 μL of 10 mM cross-linking agent (oxidant) and/or 4 μL of 30 mM complexant agent (FeCl₃).

For stronger samples, according to literature, we attached an aluminium bar at the edges of each glass bar, using commercial cyanoacrylate glue, covering a 25×50 mm total surface.

Characterization of Silk Fibroin Adhesive

Our adhesive material exhibits, among all natural bioinspired materials today known in literature, the highest value ever reached. Indeed, we obtained 1.2 MPa applying the glue on one side of the adherend. Payne, using 50 mg of copolymer with chitosan and dopamine for each side of glass platelet, obtained glues that range between 0.35 and 0.55 MPa, reporting as the highest value (Yamada, 2000).

Among synthetic adhesives, our material is still quite competitive, because typical synthetic glues require 5 mg of polymer each cm² to achieve impressive adhesion of upward of 15 MPa (Youbing, 2016). With this comparison, we still defend our natural material since we use, in proportion, 0.56 mg of polymer each cm². Moreover, Wan's adhesive involves a more complicated curing process in which high temperature (140° C.) and pressure (3 MPa) are required. Our casting procedure, in contrast, does not require any additional process unless air drying.

Furthermore, our system showed a very high adhesion ability even at underwater conditions, leaving glass samples submerged and clamped in distilled water for 24 hours (1.9 MPa). To our knowledge, the highest underwater adhesion value ever reported was 1.3 MPa (Li, 2015), performed with Poly-vinyl-pyrrolidone-dopamine derivatives. Unfortunately, this polymer requires several synthetic steps in which organic solvents (Methanol, methylene chloride) are used. They also used 3 mg of polymer per side.

In order to study adhesive properties of silk fibroin derivatives, we measured the tensile strength (shear strength) of silk fibroin on glass cured just with water. Here, we used precleaned glass (Fisherbrand, Plain, Microscope slides, 25×75×1.0 mm) bars on which we casted 20 μL of a 73 mg/mL silk fibroin solution, we let the film dry and then attached a second glass bar cured with 4 μL deionized water. Film was casted on a 25×10 mm area. Adhesion tests were performed on an INSTRON 3366 Testing Frame equipped with a 1000N load cell (Norwood, Mass.). Single lap shear testing (N=5, at minimum, for each material) was performed by mounting the adherents in the tension grips of the Instron and programming the instrument to move the grips apart at a rate of 0.5 mm/s. The test ended when the adhesive bond ruptured, and this peak load was divided by the bonded area to give adhesion for each of these materials.

At this point, we mixed silk fibroin and polydopamine in order to mimicry Mytilus genus byssal threads, composed by L-DOPA enriched polypeptides. We used silk fibroin as a polypeptidic backbone able to give stability and good cohesion to different surfaces and polydopamine for two chemical aspects. Firstly, as a crosslinker via radical oxidation reactions to link together silk fibroin chains; secondly for the high content of catechols that act as ligands for different metals, forming very stable metal complexes, as naturally shown in mussels and other Mollusca (Sever, 2004). We tested silk films obtained from solutions with three different dopamine concentration, ranging from 2 to 200 mM. For these films we used 4 μL of deionized water as a curing agent and the polymers solution was casted on one glass side.

Pure silk film gave an adhesive strength of ˜0.3 MPa, 2 mM of dopamine in a silk film gave an adhesive strength of ˜0.3 MPa, 20 mM of dopamine in silk gave an adhesive strength of ˜0.35 MPa, and 200 mM of domaine in silk gave an adhesive strength of ˜0.05 MPa. These protein-based adhesives gave tensile strengths from 0.1 to 0.6 MPa without any kind of oxidant or enzyme for cross-linking and these values are already comparable in literature for this type of bioinspired adhesives (Yamada, 2000).

To improve tensile strengths in these silk fibroin/polydopamine blends, we added an oxidant to promote radical oxidation both in fibroin and polydopamine, thus enhancing covalent interaction between two polymers. For these samples, we applied polymers solution on one glass side and cured them with 4 μL of KIO₄ solution at different concentrations dropped on the other side of glass slide.

Here we observed a significant increase of adhesion strength, since oxidative environment caused catechol oxidation, such as tyrosine moieties in silk fibroin and dopamine, thus promoting fibroin-fibroin, fibroin-dopamine and dopamine-dopamine cross-linking. The silk film without dopamine had an adhesive strength of ˜0.3 MPa, 2 mM of dopamine in silk gave an adhesive strength of ˜0.53 MPa, 20 mM of dopamine in silk gave an adhesive strength of ˜0.54 MPa, and 200 mM of dopamine in silk gave an adhesive strength of ˜0.08 MPa.

Interestingly, samples with silk fibroin and 200 mM dopamine result in a very low adhesion strength (less than 0.1 MPa), but they showed a unique feature: being re-attachable up to 5 times, without losing their adhesive ability. It is important to underline that this kind of behavior was never found in literature for such kind of adhesives. This could be assessed to the higher unoxidized catechol content that acts as a sticky component better than silk fibroin or other fibroin/polydopamine mixtures. This hypothesis is supported by the evidence that these samples showed the highest adhesive values underwater (2 MPa) in presence of Fe(III) ions. In fact, only catechols are able to strongly bind iron and other metals, whilst oxidized catechols (quinones) weakly bind metals (Pierpont, 1981) (see below to a better comprehension of underwater and iron tests).

At this point, according to Nature behavior in mussels, we used Iron (III) ions (FeCl₃) to increase adhesion between polymers with iron that acts as a supramolecular cross-linker able to coordinate up to three catechol moieties in a pH dependent way. For this experiment, we dropped a thin film on a glass platelet, allow it to dry and then drop 4 μL of FeCl₃ 0.03 M solution on the other side and stuck together. The silk film without dopamine had an adhesive strength of ˜0.7 MPa, 2 mM of dopamine in silk gave an adhesive strength of ˜1.2 MPa, and 20 mM of dopamine in silk gave an adhesive strength of ˜1.3 MPa.

Finally, we submerged and clamped samples in water for 24 hours to mimicry natural byssus adhesive underwater. The procedure was the same as described before for Fe(III) samples. The silk film without dopamine gave an adhesive strength of ˜0.1 MPa, 2 mM of dopamine in silk gave an adhesive strength of ˜0.6 MPa, 20 mM of dopamine in silk gave an adhesive strength of ˜1.0 MPa, and 200 mM of dopamine in silk gave an adhesive strength of ˜1.9 MPa.

In these conditions, we found extremely high values of tensile strength for underwater bonding in films with high dopamine concentration. We also acquired a scanning electron microscopy image of this kind of adhesive in the adhesive region and it highly resemble the porous structure of original mussel's byssus (Waite, 2005).

Here we have presented a totally water-based adhesive obtained through a very simple and inexpensive procedure. This adhesive could be really interesting for a commercial point of view, for user safety and for its bonding strength, especially underwater.

We found that the addition of Fe′ highly enhances the tensile strength and, in combination with dopamine, even the underwater adhesion skyrocketed to 2 MPa.

References—the following references are incorporated herein in their entirety by reference:
1. J. H. Waite N. H. Andersen, S. Jewhurst, C. Sun, The journal of adhesion, 2005, 81, 297-317.
2. Y., Miaoer, J. Hwang T. J. Deming, Journal of the American Chemical Society, 1999, 121, 5825-5826.
3. K. A. Burke, D. C. Roberts, D. L. Kaplan, Biomacromolecules, 2015, 17, 237-245.
4. M. Guvendiren D. A. Brass, P. B. Messersmith, K. R. Shull, The Journal of adhesion, 2009, 85, 631-645.
5. M. Youbing, X. Wan, Macromolecular rapid communications, 2016, 37, 545-550.
6. A. Li, Y. Mu, W. Jiang, X. Wan, Chemical Communications, 2015, 51, 9117-9120.
7. K. Yamada, T. Chen, G. Kumar, O. Vesnovsky, L. T. Topoleski, G. F. Payne, Biomacromolecules 2000, 1, 252-258)
8. M. J. Sever, J. T. Weisser, J. Monahan, S. Srinivasan, J. J. Wilker, Angewandte Chemie, Int. Ed., 2004, 43, 447-450.
9. C. G. Pierpont, R. M. Buchanan, Chemistry Reviews, 1981, 38, 45-87.

We claim:

1. An adhesive composition comprising:
a polymeric component comprising:
silk fibroin protein; and
a catecholamine, and
a metal cation or an oxidant, the metal cation and/or the oxidant being present in an amount sufficient to initiate complexing and/or cross-linking of the adhesive composition.

2. The adhesive composition of claim 1, wherein the polymeric component comprises the catecholamine in a dry-solids-basis amount by weight of between 0.05% and 83.0%.

3. The adhesive composition of claim 1 or 2, wherein the polymeric component comprises the catecholamine in a dry-solid-basis amount by weight of between 0.1% and 25.0%.

4. The adhesive composition of any one of the preceding claims, wherein the polymeric component comprises the catecholamine in a dry-solid-basis amount by weight of between 25.0% and 50.0%.

5. The adhesive composition of any one of the preceding claims, wherein polymeric component comprises the silk fibroin protein in a dry-solids-basis amount by weight of between 17.0% and 99.9%.

6. The adhesive composition of any one of the preceding claims, the adhesive composition comprising the oxidant.

7. The adhesive composition of the immediately preceding claims, wherein the polymeric component comprises the catecholamine in a dry-solid-basis amount by weight of between 25.0% and 50.0%, wherein the adhesive composition retains at least 75%, at least 80%, at least 85%, at least 90%, at least 95%, or at least 99% of its adhesive strength following at least 5 detachments and re-attachments.

8. The adhesive composition of either of the two immediately preceding claims, wherein the adhesive composition is substantially free of the metal cation.

9. The adhesive composition of any one of the preceding claims, wherein the oxidant is present in the adhesive composition in a dry-solids-basis amount by weight relative to the amount by weight of the silk fibroin protein and the catecholamine of between 0.001% and 1.0%.

10. The adhesive composition of any one of the preceding claims, wherein the oxidant is present in an amount sufficient to provide an oxidative environment sufficient to oxidize catechol moieties in the polymeric component to initiate cross-linking between the catechol moieties of the adhesive composition.

11. The adhesive composition of any one of the preceding claims, the composition comprising the metal cation.

12. The adhesive composition of any one of the preceding claims, the adhesive composition comprising the metal cation and the oxidant.

13. The adhesive composition of any one of the preceding claims, wherein the composition has an underwater adhesive strength of at least 0.4 MPa per 250 mm².

14. The adhesive composition of any one of the preceding claims, wherein the composition has an in-air adhesive strength of at least 0.75 MPa per 250 mm².

15. The adhesive composition of any one of the preceding claims, wherein the composition forms a film having a total polymer content of between 0.25 mg/cm² and 2.5 mg/cm².

16. A method of making an adhesive composition, the method comprising:
a) forming a film from a mixture comprising a silk fibroin protein and a catechol; and
b) contacting the film with an oxidant and/or a metal cation, thereby forming an adhesive composition.

17. A method of making an adhesive composition, the method comprising:
a) forming a film from a mixture comprising a silk fibroin protein, a catechol, and an oxidant and/or a metal cation; and
b) contacting the film with water, thereby forming an adhesive composition.

18. The method of claim 16 or 17, wherein the method is performed in the absence of organic solvents.

19. The method of any one of claim 16 to the immediately preceding claim, wherein the method is performed in the absence of alcohols.

20. The method of any one of claim 16 to the immediately preceding claim, wherein the method is performed without exceeding a temperature of 100° C.

21. The method of any one of claim 16 to the immediately preceding claim, wherein the method is performed without exceeding a pressure of 1 MPa.

22. The method of any one of claim 16 to the immediately preceding claim, wherein the silk fibroin protein, the catechol, the oxidant, and/or the metal cation have one or more of the properties identified in claims 1 to 15 or 24 to 39.

23. The method of any one of claim 16 to the immediately preceding claims, wherein the adhesive composition is the adhesive composition of any one of claims 1 to 15.

24. A kit comprising a first component and a second component, the first component comprising a mixture of silk fibroin protein and a catecholamine, the second component comprising an oxidant and/or a metal cation.

25. The kit of claim 24, wherein the first component and the second component are at least temporarily prevented from contacting one another.

26. The kit of claim 24 or 25, wherein the first component is a liquid.

27. The kit of claim 26, wherein the liquid is an aqueous solution, an aqueous suspension, or a combination thereof.

28. The kit of claim 24, wherein the first component is a solid.

29. The kit of claim 28, wherein the first component is a solid film.

30. The kit of any one of claim 24 to the immediately preceding claim, wherein the second component is an aqueous solution, an aqueous suspension, or a combination thereof.

31. The kit of claim 24, wherein the first component and the second component are present in a solid state mixture.

32. The kit of any one of claim 24 to the immediately preceding claim, wherein the catecholamine is present in the first composition in a concentration of at least 50 mM.

33. The kit of any one of claim 24 to the immediately preceding claim, wherein the catecholamine is present in the first composition in a concentration of at least 100 mM.

34. The kit of any one of claim 24 to the immediately preceding claim, wherein the catecholamine is present in the first composition in a concentration of at least 150 mM.

35. The kit of any one of claim 24 to the immediately preceding claim, wherein the catecholamine is present in the first composition in a concentration of at least 175 mM.

36. The kit of any one of claim 24 to the immediately preceding claim, wherein the catecholamine is present in the first composition in a concentration of at least 250 mM.

37. The kit of any one of claim 24 to the immediately preceding claim, wherein the catecholamine is present in the first composition in a concentration of at least 1 M.

38. The kit of any one of claim 24 to the immediately preceding claim, wherein the kit comprises a housing having a first compartment and a second compartment, wherein the first compartment contains the first component and the second compartment contains the second component.

39. The kit of any one of claim 24 to the immediately preceding claim, wherein combining the first component and the second component provides the adhesive composition of any one of claims 1 to 15.

40. The adhesive composition, the method, or the kit of any one of the preceding claims, wherein the catecholamine is a dopamine monomer.

41. The adhesive composition, the method, or the kit of any one of claim 1 to the claim immediately preceding the immediately preceding claim, wherein the dopamine is polydopamine.
